(19) United States
(12) Patent Application Publication
(10) Pub. No.: US 2018/0059761 A1
(43) Pub. Date: Mar. 1, 2018

(54) METHOD OF MANAGING POWER AND PERFORMANCE OF AN ELECTRONIC DEVICE INCLUDING A PLURALITY OF CAPACITORS FOR SUPPLYING AUXILIARY POWER

(71) Applicant: Samsung Electronics Co., Ltd., Suwon-si (KR)

(72) Inventors: Su-Yong AN, Asan-si (KR); Byung-Ok KANG, Seoul (KR); Chung-Hyun RYU, Hwaseong-si (KR)

(21) Appl. No.: 15/481,450

(22) Filed: Apr. 6, 2017

(30) Foreign Application Priority Data
Aug. 30, 2016 (KR) 10-2016-0111120

(51) Int. Cl. G06F 1/30; H02J 9/06; G06F 13/40

(52) U.S. Cl. CPC G06F 1/305; G06F 13/4068; H02J 9/061

(57) ABSTRACT

Embodiments include a method of managing power and performance of an electronic device, the method comprising: providing a plurality of capacitors configured to be electrically connected to a power rail of the electronic device to supply auxiliary power to the electronic device when interrupt occurs in input power supplied to the electronic device; monitoring states of the capacitors; and controlling operations of the electronic device based on the results of the monitoring.

### CROSS-REFERENCE TO RELATED APPLICATION

This U.S. Non-provisional application claims priority under 35 USC §119 to Korean Patent Application No. 10-2016-0111120, filed on Aug. 30, 2016, in the Korean Intellectual Property Office (KIPO), the disclosure of which is incorporated by reference in its entirety herein.

### BACKGROUND

### 1. Technical Field

Embodiments relate generally to electronic devices, and more particularly to a method of managing power and performance of an electronic device including multiple capacitors for supplying auxiliary power.

### 2. Discussion of the Related Art

According to developments of semiconductor technology, various electronic devices are developed and demand on efficient and stable power supply to the electronic device is increased. Input power to the electronic device may be supplied using a detachable and rechargeable battery or an external AC or DC power source. If an unexpected interrupt occurs in the input power, irreversible damage may be caused in the electronic device. The interrupt in the input power may occur due to various causes such as disorder of a power source itself, disconnection between the power source and the electronic device, etc. Various negative results such as mechanical damage, data loss, etc. may be caused by the interrupt in the input power.

### SUMMARY

Embodiments include a method of managing power and performance of an electronic device, the method comprising: providing a plurality of capacitors configured to be electrically connected to a power rail of the electronic device to supply auxiliary power to the electronic device when interrupt occurs in input power supplied to the electronic device; monitoring states of the capacitors; and controlling operations of the electronic device based on the results of the monitoring.

Embodiments include a method of managing power and performance of an electronic device, the method comprising: providing a plurality of capacitors configured to supply auxiliary power to the electronic device when an interrupt occurs in input power supplied to the electronic device; monitoring whether each of the capacitors is defective; controlling electrical connections between a power rail of the electronic device and each of the capacitors based on results of the monitoring; monitoring a total capacitance of all of the capacitors that are connected electrically to the power rail for supplying the auxiliary power; and controlling operations of the electronic device based on the total capacitance.

Embodiments include a method comprising: measuring capacitances of a plurality of capacitors of an electronic device; and changing an operation of the electronic device based on the capacitances of the capacitors; wherein the capacitors are configured to supply auxiliary power to the electronic device when an interrupt occurs in input power supplied to the electronic device.

### BRIEF DESCRIPTION OF THE DRAWINGS

Embodiments will be more clearly understood from the following detailed description taken in conjunction with the accompanying drawings.

FIG. 1 is a flow chart illustrating a method of managing power and performance of an electronic device according to some embodiments.

FIG. 2 is a block diagram illustrating an electronic device according to some embodiments.

FIG. 3 is a diagram illustrating an embodiment of a capacitor module included in the electronic device of FIG. 2.

FIG. 4 is a block diagram illustrating an embodiment of a power loss protection (PLP) circuit included in the electronic device of FIG. 2.

FIG. 5 is a flow chart illustrating an embodiment of monitoring states of the capacitors for the method of FIG. 1.

FIGS. 6 and 7 are diagrams illustrating embodiments of a capacitor module included in the electronic device of FIG. 2.

FIG. 8 is a block diagram illustrating a system including a storage device according to some embodiments.

FIG. 9 is a block diagram illustrating a memory device included in the storage device in FIG. 8.

FIGS. 10A, 10B and 10C are diagrams illustrating examples of a memory cell array included in the memory device of FIG. 9.

FIG. 11 is a diagram illustrating an embodiment of controlling operations of an electronic device for the method of FIG. 1.

FIG. 12 is a diagram illustrating another embodiment of controlling operations of an electronic device for the method of FIG. 1.

FIG. 13 is a diagram illustrating a task queue included in the storage device in FIG. 8.

FIG. 14 is a block diagram illustrating a mobile device according to some embodiments.

### DETAILED DESCRIPTION OF THE EMBODIMENTS

Various embodiments will be described more fully hereinafter with reference to the accompanying drawings, in which some embodiments are shown. In the drawings, like numerals refer to like elements throughout. The repeated descriptions may be omitted.

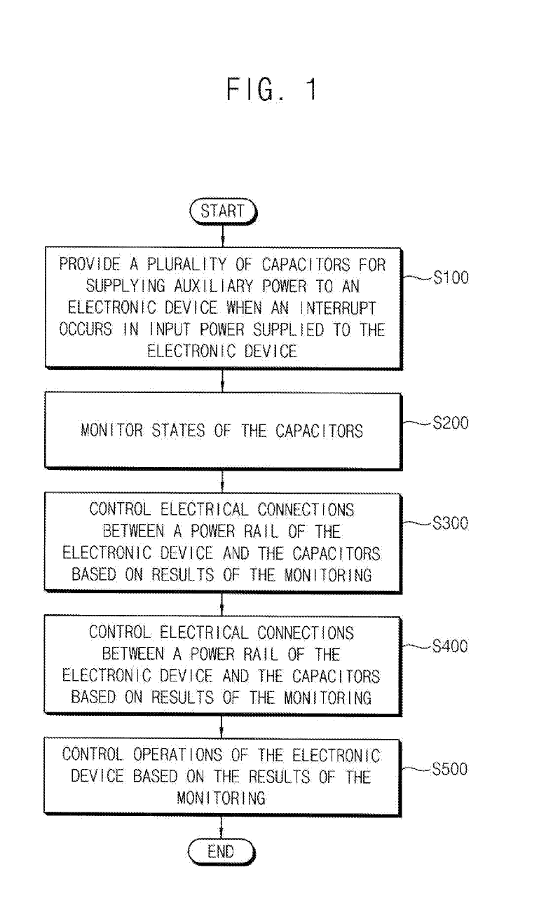

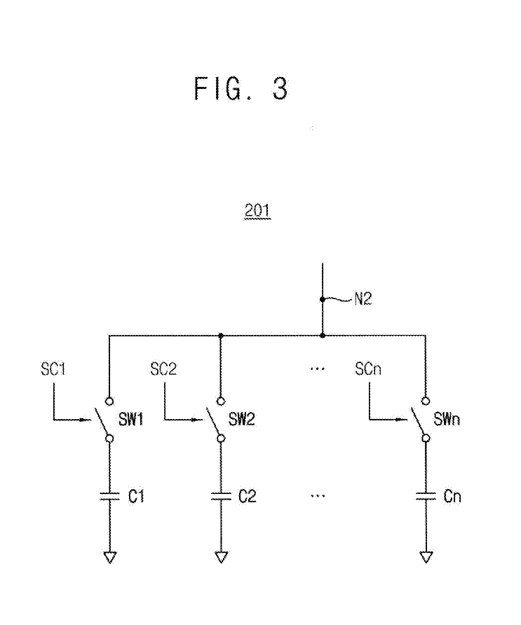

FIG. 1 is a flow chart illustrating a method of managing power and performance of an electronic device according to some embodiments. Referring to FIG. 1, multiple capacitors are provided for supplying auxiliary power to the electronic device when an interrupt occurs in input power supplied to the electronic device (S100). The interrupt of the input power may occur due to various causes such as disorder of power source itself, disconnection between the power source and the electronic device, etc., which may not be intended by a user. The configuration and the operation of the capacitors for supplying the auxiliary power will be described below with respect to FIGS. 3, 7, and 8.

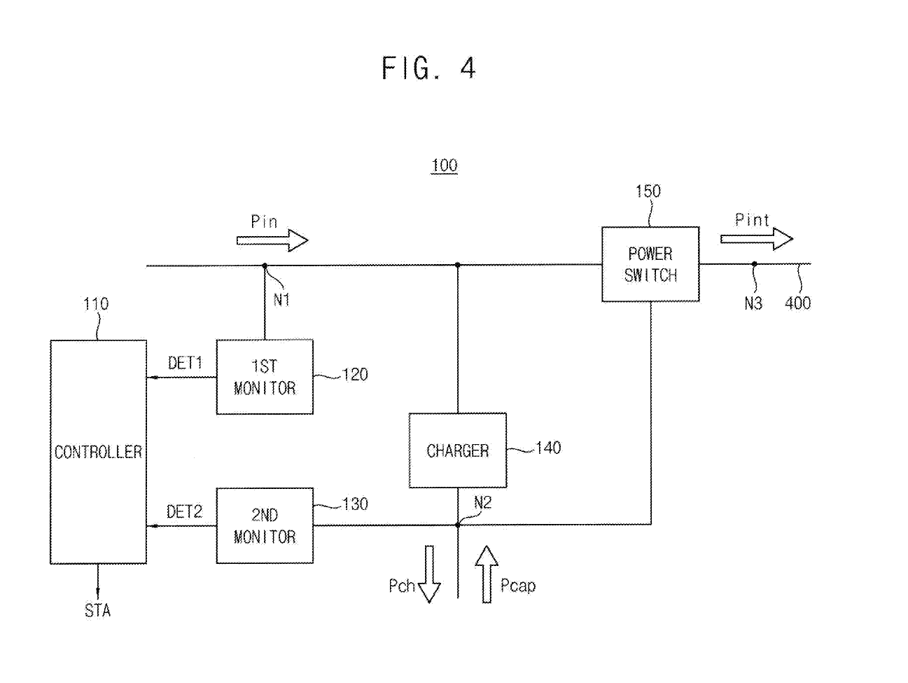

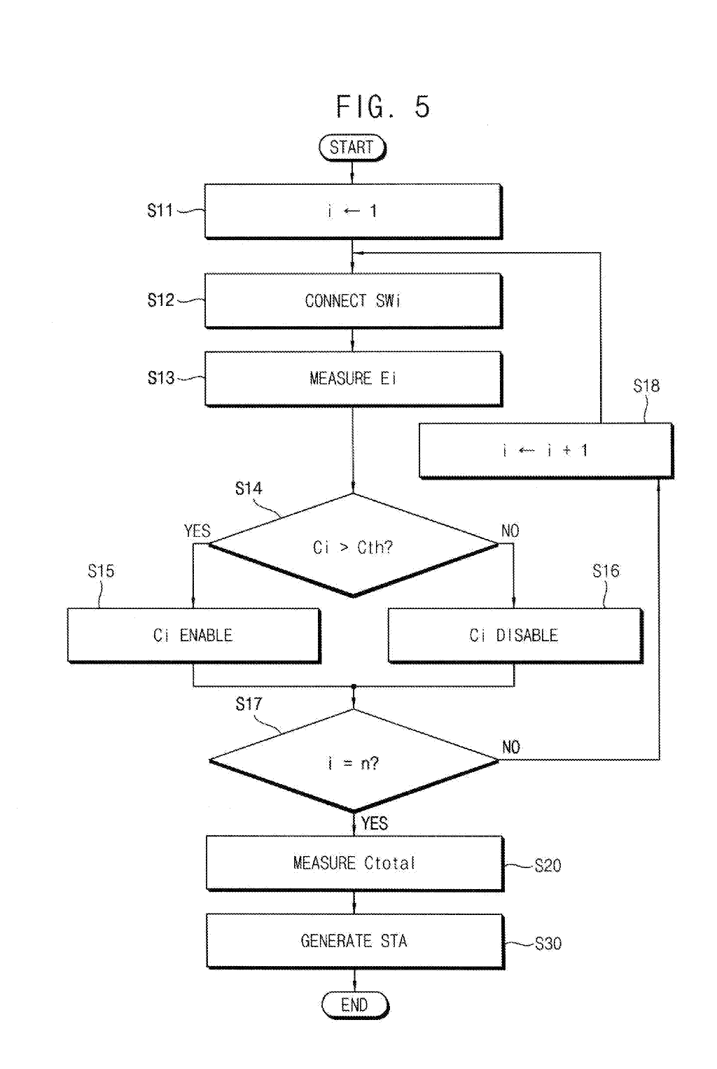

States of the capacitors are monitored (S200). In some embodiments, monitoring of the states of the capacitors may include monitoring whether each of the capacitors is defective. In some embodiments, monitoring the states of the capacitors may include measuring a capacitance of one or more of the capacitors. In some embodiments, monitoring the states of the capacitors may include monitoring a total capacitance of all of the capacitors that are connected electrically to a power rail. Such monitoring will be described below with reference to FIGS. 4 and 5.

Electrical connections between the power rail of the electronic device and the capacitors may be based on results of the monitoring (S300). The control of the electrical connections will be described below with reference to FIGS. 3, 7 and 8. By monitoring whether each capacitor is defective, the auxiliary power may be supplied using the normal capacitors even though some capacitors are defective and thus life span and reliability of the electronic device may be enhanced.

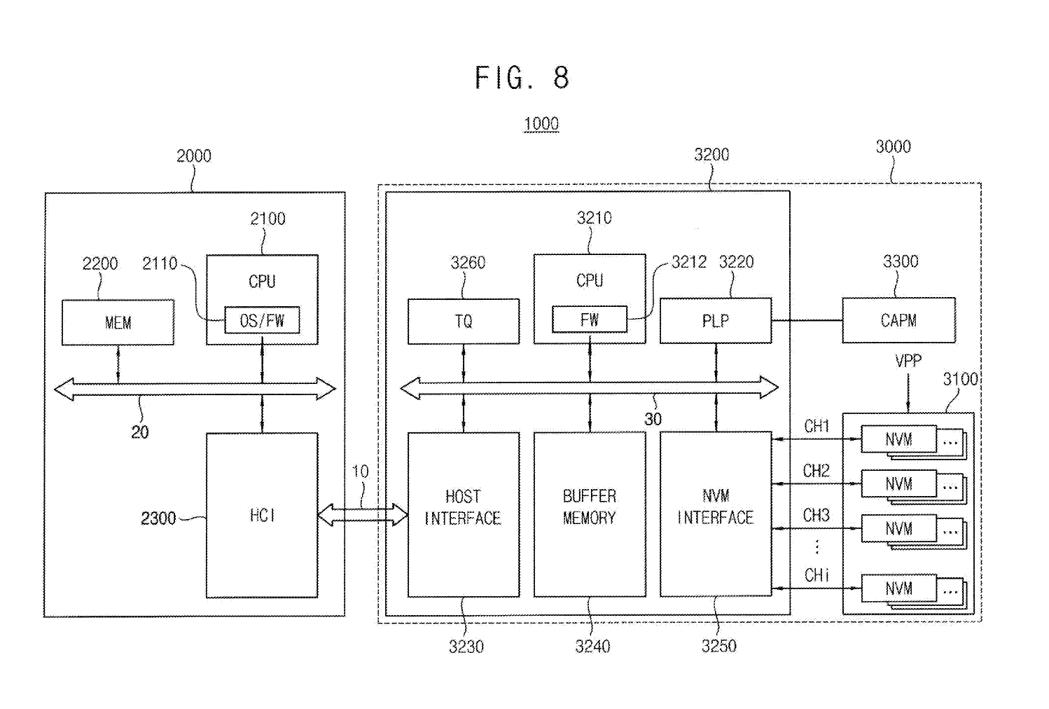

Operations of the electronic device may be controlled based on the results of the monitoring (S400). The control of the operations of the electronic device will be described with reference to FIGS. 8 through 13. By monitoring the total capacitance of all of the capacitors that are used to supply the auxiliary power, the operations of the electronic device may be controlled depending on degree of degeneration of the capacitors and thus life span and reliability of the electronic device may be enhanced.

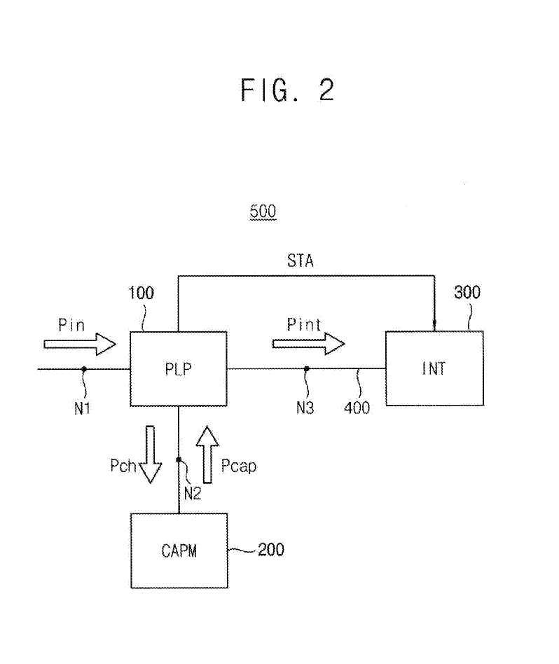

FIG. 2 is a block diagram illustrating an electronic device according to some embodiments. Referring to FIG. 2, an electronic device 500 may include a power loss protection circuit (PLP) 100, a capacitor module (CAPM) 200, an internal circuit (INT) 200 and a power rail 400.

The power loss protection circuit 100 may receive input power Pin through a first node N1. The power loss protection circuit 100 may provide charging power Pch to the capacitor module 200 or receive auxiliary power Pcap from the capacitor module 200 through a second node N2. The power loss protection circuit 100 may provide at least one of the input power Pin and the auxiliary power Pcap, including a combination of the input power Pin and the auxiliary power Pcap, to the internal circuit 300 through a third node N3. The third node N3 is a node on the power rail 400 for supplying power to the internal circuit 300.

The capacitor module 200 may include multiple capacitors for supplying the auxiliary power Pcap as will be described below with reference to FIG. 3. The capacitors may be disposed in parallel between the second node N2 and a ground node. Each of the capacitors may be connected electrically to the second node N2 by control of the power loss protection circuit 100. The internal circuit 300 may have various configurations depending on a kind of the electronic device 500. For example, as will be described below with reference to FIG. 8, the electronic device 500 may be a storage device such as a solid state drive (SSD), an embedded multimedia card (eMMC), a universal flash storage (UFS) device, etc. and the internal circuit 300 may include non-volatile memory and circuits for controlling the non-volatile memory.

The power loss protection circuit 100 may monitor states of the capacitors included in the capacitor module 200. The power loss protection circuit 100 may monitor whether each of the capacitors is defective to control the electrical connections between the power rail 400 and each of the capacitors based on defectiveness or normality of each capacitor. In addition, the power loss protection circuit 100 may monitor the total capacitance of all capacitors that are connected electrically to the power rail 400 for supplying the auxiliary power Pcap to control the operations of the electronic device 500 based on the total capacitance. The power loss protection circuit 100 may include a controller, a charger, a monitor, a power switch, etc. for such control of power and performance of the electronic device 500 as will be described below with reference to FIG. 4.

In some embodiments, the power loss protection circuit 100 may generate a state signal STA indicating the total capacitance and provide the state signal STA to the internal circuit 300 of the electronic device 500. The state signal STA may be a multi-bit signal indicating the total capacitance or a value corresponding to the total capacitance. The internal circuit 300 may control the operations of the electronic device 500 based on the state signal STA.

FIG. 3 is a diagram illustrating an embodiment of a capacitor module included in the electronic device of FIG. 2. Referring to FIG. 3, a capacitor module 201 may include multiple capacitors C1˜Cn and multiple switches SW1˜SWn. The capacitors C1˜Cn may disposed in parallel between the second node N2 and the ground node and the switches SW1˜SWn may be disposed between the second node N2 and the capacitors C1˜Cn to electrically connect the capacitors C1˜Cn to the second node N2 respectively. The switches SW1˜SWn may be turned on independently in response to each of the switch control signals SC1˜SCn and thus only the capacitors corresponding to the turned-on switches may be electrically connected to the second node N2. The switch control signals SC1˜SCn may be provided from the power loss protection circuit 100.

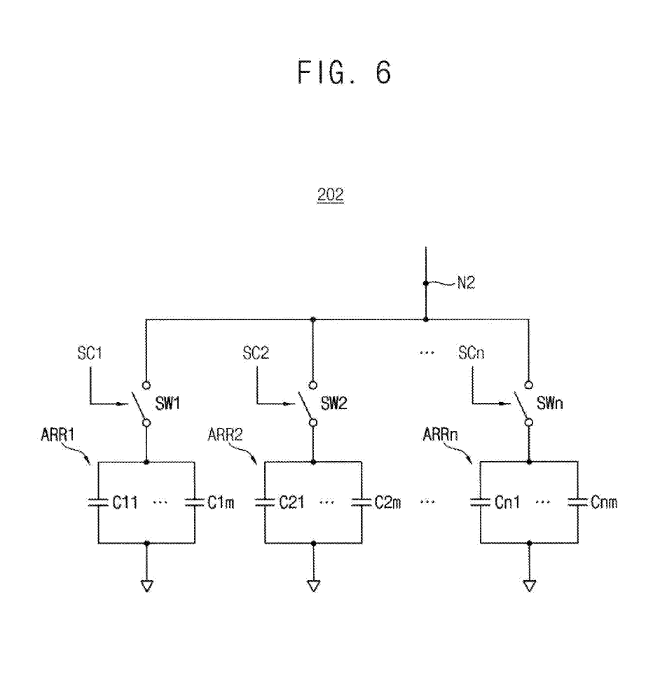

FIG. 3 illustrates a non-limiting embodiment that one switch corresponds to one capacitor. In some embodiments, one switch may correspond to a capacitor array including multiple capacitors as illustrated in FIG. 6. In this disclosure, a capacitor may represent an arbitrary component that can store electric charge. Ci may be used to indicate an i-th capacitor or its capacitance.

FIG. 4 is a block diagram illustrating an embodiment of a power loss protection (PLP) circuit included in the electronic device of FIG. 2. Referring to FIG. 4, a power loss protection circuit 100 may include a controller 110, a first monitor 120, a second monitor 130, a charger 140 and a power switch 150.

The controller 110 may control overall operations of the power loss protection circuit 100. For example, the controller 110 may generate the switch control signals SC1˜SCn for controlling the electrical connections of the capacitors C1˜Cn as described with reference to FIG. 3. Such control signals are omitted in FIG. 4.

The first monitor 120 may monitor input power Pin provided through the first node N1 to generate a first detection signal DET1. Monitoring of the input power Pin may be implemented with various methods. For example, the first monitor 120 may monitor the input power Pin based on a voltage at the first node N1. If the voltage at the first node N1 becomes lower than a reference level, the first monitor 120 may determine that the interrupt in the input power Pin has occurred and activate the first detection signal DET1 to inform the controller 110 of the interrupt.

The second monitor 130 may monitor states of the capacitors C1˜Cn included in the capacitor module 200. Monitoring of the states of the capacitors C1˜Cn may be implemented with various methods. For example, the second monitor 130 may monitor the states of the capacitors C1˜Cn based on a voltage and/or a current at the second node N2.

In some embodiments, the second monitor 130 may monitor whether each of the capacitors C1˜Cn is defective. To monitor the defectiveness of each capacitor, the controller 110 may activate selectively one control signal SCi of the switch control signals SC1˜SCn to electrically connect each of the capacitors C1˜Cn as a test capacitor Ci to a test node, that is, the second node N2. While only the one test capacitor Ci is electrically connected to the second node N2, the second monitor 130 may measure a voltage and/or a current at the second node N2 to provide a second detection signal DET2 including information on the voltage and/or the current to the controller 110. The controller 110 may measure or calculate an individual capacitance of the test capacitor Ci based on the second detection signal DET2. As will be described below with reference to FIG. 5, the defectiveness or the normality of the test capacitor Ci may be determined based on the individual capacitance.

In some embodiments, the second monitor 130 may monitor a total capacitance of all of the capacitors that are connected electrically to the power rail 400 for supplying the auxiliary power Pcap. To monitor the total capacitance, the controller 110 may activate selectively the switch control signals SC1˜SCn corresponding to the normal capacitors among the capacitors C1˜Cn to electrically connect the normal capacitors to the second node N2. While the normal capacitors are electrically connected to the second node N2, the second monitor 130 may measure a voltage and/or a current at the second node N2 to provide the second detection signal DET2 including information on the voltage and/or the current to the controller 110. The controller 110 may measure or calculate the total capacitance of the normal capacitors connected to the second node N2 for supplying the auxiliary power Pcap, based on the second detection signal DET2. As will be described below with reference to FIGS. 8 through 13, the operations of the electronic device may be controlled based on the total capacitance.

The charger 140 may provide charging power Pch for charging the capacitors C1˜Cn included in the capacitor module 201 of FIG. 4 based on the input power Pin. The timing of the charging operation may be controlled by a control signal from the controller 110. The charging operation may be performed periodically or non-periodically.

The power switch 150 may electrically connect the first node N1 and/or the second node N2 to the third node N3 in response to a control signal from the controller 110. The input power Pin may be provided as internal power Pint to the internal circuit 300 through the power rail 400 when the first node N1 is electrically connected to the third node N3. The auxiliary power Pcap may be provided as the internal power Pint to the internal circuit 300 through the power rail 400 when the second node N2 is electrically connected to the third node N3.

In some cases, the first node N1 and the second node N2 may be electrically connected to the third node N3 at the same time and thus sum of the input power Pin and the auxiliary power Pcap may be provided as the internal power Pint to the internal circuit 300. According to the switching operation of the power switch 150, the first node N1 and/or the second node N2 may be considered as being included in the power rail 400 as the third node N3.

FIG. 5 is a flow chart illustrating an embodiment of monitoring states of the capacitors for the method of FIG. 1. As illustrated in FIG. 5, it is determined in advance whether each of the capacitors C1˜Cn is defective (S11˜S17), and then the total capacitance Ctotal of the capacitors that are determined as being normal and to be used to supply the auxiliary power Pcap may be measured (S20).

Referring to FIGS. 2 through 5, the controller 110 may initialize a test parameter i to one (S11). The test parameter i is an index to indicate one of the capacitors C1˜Cn. The controller 110 may activate one switch control signal SCi among the switch control signals SW1˜SWn and thus the test capacitor Ci corresponding to the switch control signal SCi among the capacitors C1˜Cn may be electrically connected to the second node N2 or the power rail 400 (S12). The other capacitors may be electrically disconnected from the second node N2. In this state, the second monitor 130 may measure the voltage and/or the current at the second node N2 to provide the second detection signal DET2 to the controller 110. The controller 110 may measure or calculate the individual capacitance Ci of the test capacitor based on the second detection signal DET2 (S13).

The controller 110 may compare the individual capacitance Ci with a reference value Cth (S14) to determine whether each capacitor, that is, the test capacitor is defective. When the individual capacitance Ci is greater than the reference value Cth (S14: YES), the controller 110 may determine that the test capacitor is normal and enable the test capacitor (C15). In contrast, when the individual capacitance Ci is smaller than the reference value Cth (S14: NO), the controller 110 may determine that the test capacitor is defective and disable the test capacitor (S16).

Enabling of the test capacitor Ci may represent electrically connecting the test capacitor Ci to the second node N2 so that the test capacitor Ci may be used in supplying the auxiliary power Pcap, and disabling of the test capacitor Ci may represent electrically disconnecting the test capacitor Ci from the second node N2 so that the test capacitor Ci may be excluded from supplying the auxiliary power Pcap.

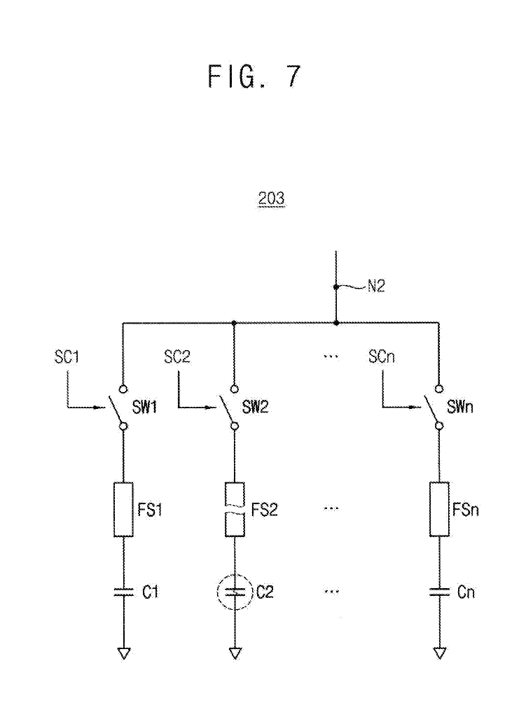

In some embodiments, the selective enabling of the capacitors may be implemented by the selective activation of the above-described switch control signals SC1˜SCn. In other embodiments, the selective enabling of the capacitors may be implemented by selective cutting of fuses as will be described below with reference to FIG. 7.

When the test parameter i is not equal to the total number n of the capacitors C1˜Cn (S17: NO), the test parameter i is increased by one (S18) and the above processes (S12, S13, S14, S15, S16) are repeated. When the test parameter i is equal to the total number n of the capacitors C1˜Cn (S17: YES), monitoring of the defectiveness is completed with respect to all of the capacitors C1˜Cn.

After the defectiveness or the normality of all of the capacitors C1˜Cn is completed, the power loss protection circuit 100 may measure the total capacitance Ctotal of all of the normal capacitors that are electrically connected to the second node N2 for supplying the auxiliary power Pcap (S20). The measurement of the total capacitance Ctotal may be performed while all of the normal capacitors are electrically connected to the second node N2.

The controller 110 may activate selectively the switch control signals SC1˜SCn corresponding to the normal capacitors among the capacitors C1˜Cn to electrically connect the normal capacitors to the second node N2. While the normal capacitors are electrically connected to the second node N2, the second monitor 130 may measure the voltage and/or the current at the second node N2 to provide the second detection signal DET2 including information on the voltage and/or the current to the controller 110. The controller 110 may measure or calculate the total capacitance Ctotal of the normal capacitors connected to the second node N2 for supplying the auxiliary power Pcap, based on the second detection signal DET2.

In some embodiments, the measurement of the total capacitance Ctotal of all of the normal capacitors may be performed differently. For example, the measurement of the total capacitance Ctotal of all of the normal capacitors may include summing of the individual capacitances of the normal capacitors to generate the total capacitance Ctotal.

According to some embodiments, the controller 110 of the power loss protection circuit 100 may generate a state signal STA indicating the total capacitance Ctotal (S30), and may provide the state signal STA to the internal circuit 300 of the electronic device 500. The state signal STA may be a multi-bit signal indicating the total capacitance or a value corresponding to the total capacitance. The internal circuit 300 may control the operations of the electronic device 500 based on the state signal STA.

FIGS. 6 and 7 are diagrams illustrating embodiments of a capacitor module included in the electronic device of FIG. 2. Referring to FIG. 6, a capacitor module 202 may include multiple capacitor arrays, that is, first through n-th ARR1˜ARRn and multiple switches SW1˜SWn. Each of the capacitor arrays ARR1˜ARRn may include multiple capacitors. For example, the first capacitor array ARR1 may include m capacitors C11˜C1m, the second capacitor array ARR2 may include m capacitors C21˜C2m, and in this way the n-th capacitor array ARRn may include m capacitors Cn1˜Cnm. In some embodiments, the number of capacitors in one or more of the capacitor arrays ARR1˜ARRn may be different from one or more of the other capacitor arrays ARR1˜ARRn.

The capacitor arrays ARR1˜ARRn may disposed in parallel between the second node N2 and the ground node and the switches SW1˜SWn may be disposed between the second node N2 and the capacitor arrays ARR1˜ARRn to electrically connect the capacitor arrays ARR1˜ARRn to the second node N2 respectively.

The switches SW1˜SWn may be turned on independently in response to each of the switch control signals SC1˜SCn and thus only the capacitor arrays corresponding to the turned-on switches may be electrically connected to the second node N2. The switch control signals SC1˜SCn may be provided from the power loss protection circuit 100.

Referring to FIG. 7, a capacitor module 203 may include multiple capacitors C1˜Cn, multiple switches SW1˜SWn and multiple fuses FS1˜FSn. The capacitors C1˜Cn may disposed in parallel between the second node N2 and the ground node. The switches SW1˜SWn and the fuses FS1˜FSn may be disposed between the second node N2 and the capacitors C1˜Cn to electrically connect the capacitors C1˜Cn to the second node N2 respectively.

The switches SW1˜SWn may be turned on independently in response to each of the switch control signals SC1˜SCn and thus only the capacitors corresponding to the turned-on switches may be electrically connected to the second node N2. The switch control signals SC1˜SCn may be provided from the power loss protection circuit 100.

The fuses FS1˜FSn may be cut selectively so as to disconnect the corresponding capacitors from the second node N2 electrically and permanently. For example, if the second capacitor C2 is shorted and determined as being defective, the second fuse FS2 may be cut and thus the second capacitor C2 may be disconnected from the second node N2 electrically and permanently. The fuses FS1˜FSn may be implemented with various fuses such as fuses to be cut using laser, electrical fuses to be cut using high voltage or high current, etc.

Although fuses are described on a one-to-one basis with capacitors, in other embodiments, the association may be different. For example, each of one or more the fuses may be electrically connected between a capacitor array as described in FIG. 6 and the second node N2.

FIG. 8 is a block diagram illustrating a system including a storage device according to some embodiments. Referring to FIG. 8, a system 1000 includes a host device 2000 and a storage device 3000. For example, the host device 2000 may be an embedded multimedia card (eMMC), a solid state drive (SSD), etc.

The host device 2000 may be configured to control data processing operations, such as data read operations and data write operations. The data processing operations may be performed at a single data rate (SDR), a double data rate (DDR), or the like.

The host device 2000 may be a data processing device, such as a central processing unit (CPU), a processor, a microprocessor, or an application processor, which can process data. The host device 2000 and the storage device 3000 may be embedded or implemented in an electronic device. The system 1000 of FIG. 8 may be an arbitrary electronic device such as a personal computer (PC), a laptop computer, a mobile telephone, a smart phone, a tablet PC, a personal digital assistant (PDA), an enterprise digital assistant (EDA), a digital still camera, a digital video camera, an audio device, a portable multimedia player (PMP), a personal navigation device or portable navigation device (PND), an MP3 player, a handheld game console, an e-book, etc.

When the system 1000 is an electronic device, the storage device 3000 may be electrically connected with other components of the system 1000 (electronic device) through connection means (e.g., pads, pins, buses, or communication lines) to communicate with the host device 2000.

The host device 2000 may include a processor (CPU) 2100, memory (MEM) 2200 and a host controller interface (HCI) 2300. Operating system (OS) and/or host firmware (FW) 2110 may be executed by the processor 2100. The host device 2000 may also include a clock generator (not shown), a state control unit (not shown), etc. The clock generator generates a clock signal used in the host 2000 and the storage device 3000. The clock generator may be implemented by a phase locked loop (PLL), for example.

The processor 2100 may include hardware and/or software for controlling generation of a command CMD, analysis of a response RES, storing of data in a register, e.g., an extended (EXT)_CSD register (not shown), of the storage device 3000, and/or data processing. The processor 2100 may execute the operation system and the host firmware 2110 to perform these operations.

The host controller interface 2300 may interface with the storage device 3000. For example, the host controller interface 2300 is configured to issue the command CMD to the storage device 3000, receive the response RES to the command CMD from the storage device 3000, transmit write data to the storage device 3000, and receive read data from the storage device 3000.

The storage device 3000 may include multiple non-volatile memory devices (NVM) 3100, a storage controller 3200 and a capacitor module (CAPM) 3300.

The nonvolatile memory devices 3100 may be optionally supplied with an external high voltage VPP. The nonvolatile memory devices 3100 may be implemented with flash memory, ferroelectric random access memory (FRAM), phase-change random access memory (PRAM), magnetic random access memory (MRAM), etc.

The storage controller 3200 may be connected to the nonvolatile memory devices 3100 through multiple channels CH1 to CHi. The storage controller 3200 may include one or more processors 3210, a power loss protection circuit 3220, a host interface 3230, a buffer memory 3240, a nonvolatile memory interface 3250 and a task queue 3260.

As described above, the power loss protection circuit 3220 may monitor the states of the capacitors included in the capacitor module 3300 and control the electrical connections between the capacitors and the power rail of the storage device 3000 and operations of the storage device 3000 based on the results of the monitoring.

The buffer memory 3240 may store data used to operate the storage controller 3200. Although FIG. 8 illustrates an embodiment where the buffer memory 3240 is included in the storage controller 3200, the buffer memory 3240 is not limited thereto. For example, the buffer memory 3240 may be placed outside the storage controller 3200.

The processor 3210 is configured to control overall operations of the storage controller 3200. For example, the processor 3210 may operate firmware 3212 including a flash translation layer (FTL), etc. The FTL may perform various functions, e.g., address mapping, read calibration, error correction, etc.

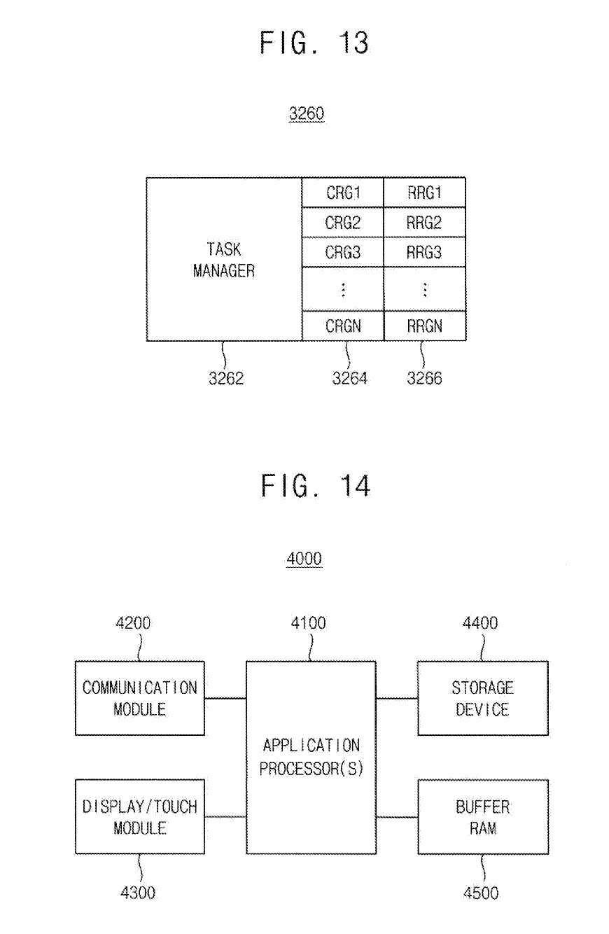

The task queue 3260 may store tasks (e.g., write tasks and read tasks provided from the host device 2000) and status information of the respective tasks. Although FIG. 8 shows that the task queue 3260 is outside the host interface 3230, the task queue 3260 may be included in the host interface 3230. The task queue 3260 will be further described below with reference to FIG. 13.

The host interface 3230 may provide an interface with external devices such as the host device 2000. The nonvolatile memory interface 3250 may provide an interface with the nonvolatile memory devices 3100.

The host device 2000 and the storage device 3000 may be connected through a bus 10. For example, the bus 10 in FIG. 8 may be an eMMC bus that is specified in JESD84-B51, including eleven signal lines or wires. The eMMC bus may include a clock line, a data strobe line, a bidirectional command signal line, a reset line and multiple data lines. However, the bus line 10 is not limited to an eMMC bus.

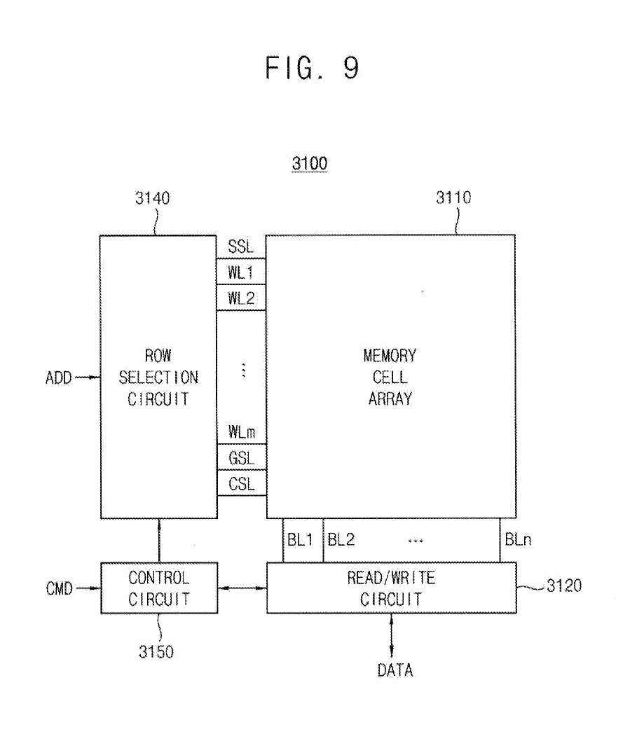

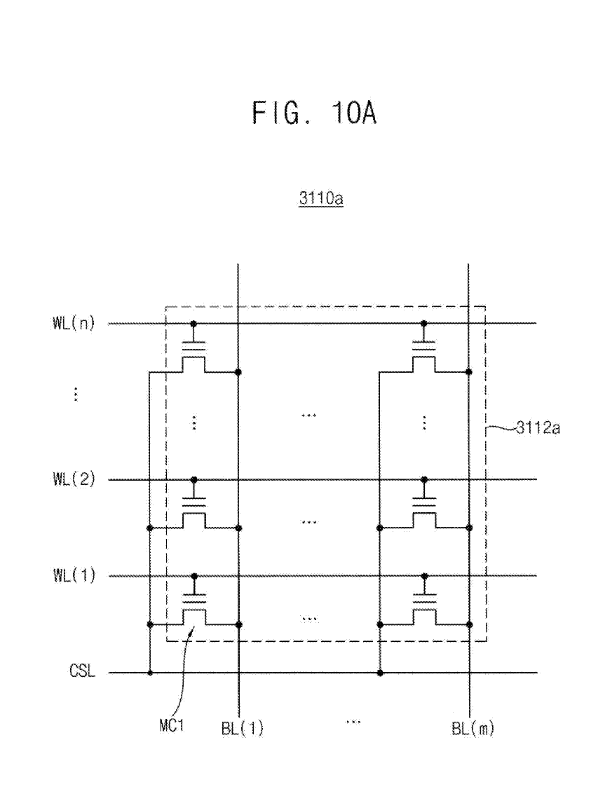

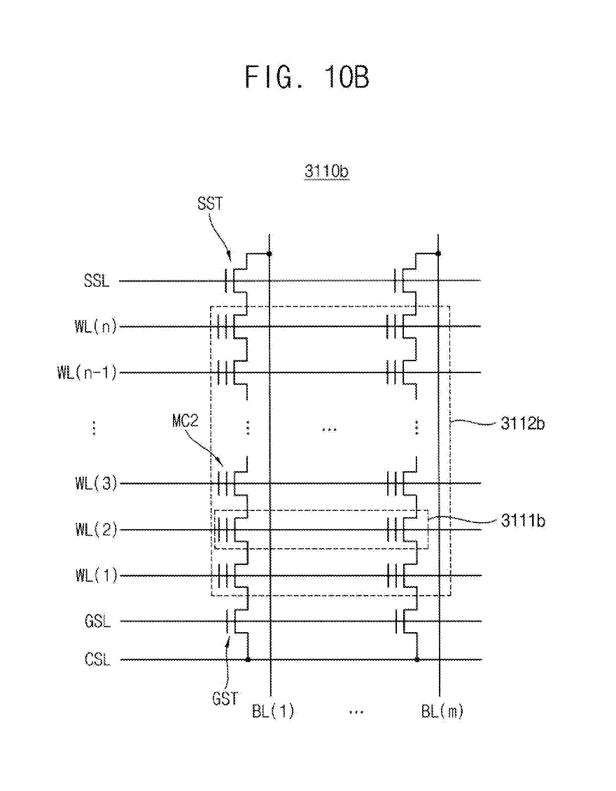

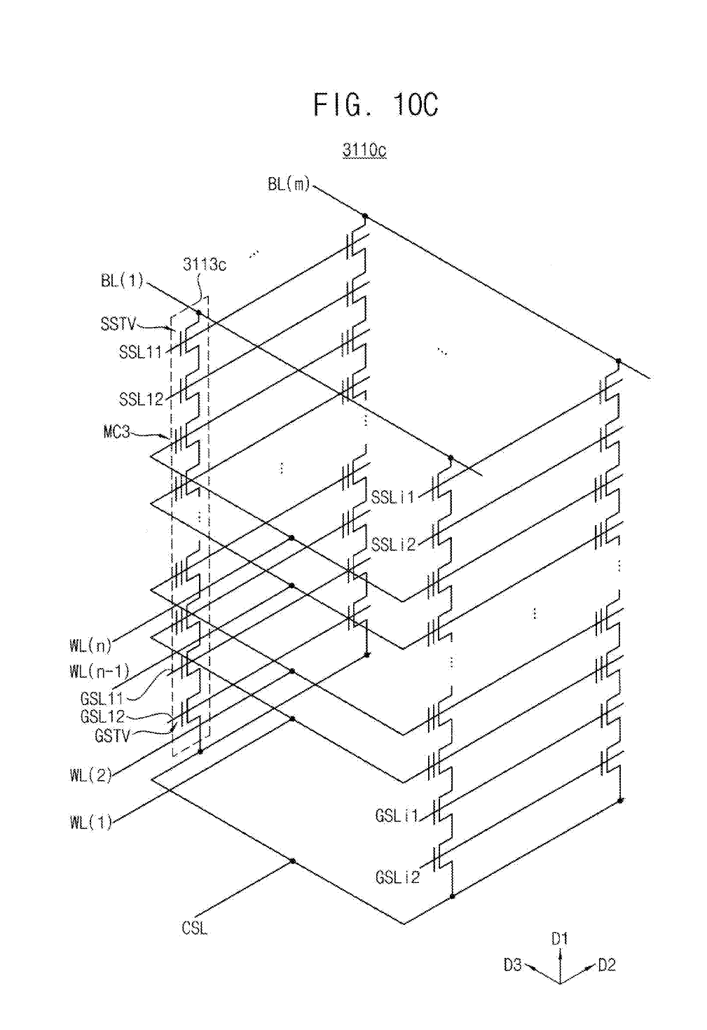

FIG. 9 is a block diagram illustrating a memory device included in the storage device in FIG. 8, and FIGS. 10A, 10B and 10C are diagrams illustrating examples of a memory cell array included in the memory device of FIG. 9. For convenience of description, a NAND flash memory device is illustrated in FIGS. 9, 10A, 10B and 10C as an example of the non-volatile memory device.

Referring to FIG. 9, a flash memory device 3100 may include a memory cell array 3110, a read/write circuit 3120, a row selection circuit 3140 and a control circuit 3150. The memory cell array 3110 may include multiple memory cells. Each memory cell may store one-bit data or multi-bit data.

The memory cell storing one bit may be referred to as a single-level cell (SLC) and the memory cell storing multiple bits may be referred to as a multi-level cell (MLC). The memory cell array 3110 may include a main region for storing general data and a spare region for storing additional information including, for example, flag information, error correction code, device code, maker code, page information etc. In some embodiments, the main region may include the MLCs and the spare region may include SLCs or MLCs.

The memory cell array 3110 may include multiple memory cells that are disposed at cross points of multiple rows or word lines and multiple columns or bit lines. The memory cells in the memory cell array 3110 may form multiple memory blocks.

The control circuit 3150 may control the overall operations associated with the write, read and erase operations of the flash memory device 3100. The data to be programmed may be loaded to the read/write circuit 3120 under control of the control circuit 3150. During the program operation, the control circuit 3150 may control the row selection circuit 3140 and the read/write circuit 3120 so that the program voltage Vpgm is applied to the selected word line, the program pass voltage Vpass is applied to the unselected word lines, and the bulk bias voltage (e.g., 0V) is applied to the bulk of the memory cells.

The program voltage Vpgm may be generated according to incremental step pulse programming (ISPP). The level of the program voltage Vpgm may be increased or decreased sequentially by a voltage interval as the program loops are repeated. The number of the program pulses, the voltage levels of the program pulses, the duration time of each program pulse, etc. may be determined by the control circuit 3150 or by an external memory controller.

The control circuit 3150 may generate the bulk voltage or the word line voltages, such as the program voltage Vpgm, the pass voltage Vpass, the program verification voltage Vpvf, the read voltage Vread, etc. The row selection circuit 3140 may select one memory block in the memory cell array 3110 and one word line in the selected memory block, in response to the row address and the control signals from the control circuit 3150. The row selection circuit 3140 may provide the corresponding word line voltages to the selected word line and the unselected word lines in response to the control signals from the control circuit 150.

The read/write circuit 3120 is controlled by the control circuit 3150 to operate as a sense amplifier or a write driver depending on the operation mode. For example, the read/write circuit 3120 may operate as a sense amplifier for reading out the data from the memory cell array 3110 during a verification read operation or a normal read operation. The data output during a normal read operation may be provided to an external device, such as a memory controller or a host device, while the data output during a verification read operation may be provided to a pass/fail verification circuit (not shown).

In case of a write operation, the read/write circuit 3120 may operate as the write driver for driving the bit lines based on the data to be written in the memory cell array 3110. The read/write circuit 3120 may receive the data from the external device and drive the bit lines based on the received data. The read/write circuit 3120 may include multiple page buffers corresponding to multiple rows of bit lines.

In programming the memory cells coupled to the selected word line, the program voltage Vpgm and the program verification voltage Vpvf may be applied alternatively to the selected word line. For the verification operation, the bit lines coupled to the selected memory cells may be precharged. The voltage change of the precharged bit line may be detected by the corresponding page buffer. The detected data during the verification read operation may be provided to the pass/fail verification circuit to determine whether the corresponding memory cell has been programmed successfully.

FIG. 10A is a circuit diagram illustrating a memory cell array included in a NOR flash memory device, FIG. 10B is a circuit diagram illustrating a memory cell array included in a NAND flash memory device, and FIG. 10C is a circuit diagram illustrating a memory cell array included in a vertical flash memory device.

Referring to FIG. 10A, a memory cell array 3110a may include multiple memory cells MC1. Memory cells in the same column may be connected in parallel between one of bitlines BL(1), . . . , BL(m) and a common source line CSL. Memory cells in the same row may be commonly connected to the same wordline among wordlines WL(1), . . . , WL(n). For example, memory cells in a first column may be connected in parallel between a first bitline BL(1) and the common source line CSL. Memory cells in a first row may be commonly connected to a first wordline WL(1). The memory cells MC1 may be controlled by a voltage on the wordlines WL(1), . . . , WL(n).

In the NOR flash memory device including the memory cell array 3110a, a read operation and a program operation may be performed per byte or word, and an erase operation may be performed per block 3112a. In the program operation, a bulk voltage having a range of about −0.1 to −0.7 volts may be applied to a bulk substrate of the NOR flash memory device.

Referring to FIG. 10B, the memory cell array 3110b may include string select transistors SST, ground select transistors GST and multiple memory cells MC2. The string select transistors SST may be connected to bitlines BL(1), . . . , BL(m), and the ground select transistors GST may be connected to a common source line CSL. The memory cells MC2 may be connected in series between the string select transistors SST and the ground select transistors GST. Memory cells in the same row may be connected to the same wordline among wordlines WL(1), . . . , WL(n). For example, 16, 32 or 64 wordlines may be disposed between a string select line SSL and a ground select line GSL.

The string select transistors SST may be connected to the string select line SSL, and may be controlled by a voltage on the string select line SSL. The ground select transistors GST may be connected to the ground select line GSL, and may be controlled by a voltage on the ground select line GSL. The memory cells MC2 may be controlled by a voltage on the wordlines WL(1), . . . , WL(n).

In the NAND flash memory device including the memory cell array 3110b, a read operation and a program operation may be performed per page 3111b, and an erase operation may be performed per block 3112b. During the program operation, a bulk voltage having a level of about 0 volt may be applied to a bulk substrate of the NAND flash memory device. For example, each page buffer may be connected to an odd-numbered bitline and an even-numbered bitline. In this case, the odd-numbered bitlines may form odd-numbered pages, the even-numbered bitlines may form even-numbered pages, and program operations for the odd-numbered pages and the even-numbered pages may be alternately performed.

Referring to FIG. 10C, a memory cell array 3110c may include multiple strings 3113c each of which has a vertical structure. The strings 3113c may be formed in a second direction to define a string column, and multiple string columns may be formed in a third direction to define a string array. Each string may include string select transistors SSTV, ground select transistors GSTV, and multiple memory cells MC3 that are formed in a first direction D1 and are connected in series between the string select transistors SSTV and the ground select transistors GSTV.

The string select transistors SSTV may be connected to bitlines BL(1), . . . , BL(m), and the ground select transistors GST may be connected to a common source line CSL. The string select transistors SSTV may be connected to string select lines SSL11, SSL12, . . . , SSLi1, SSLi2, and the ground select transistors GSTV may be connected to ground select lines GSL11, GSL12, . . . , GSLi1, GSLi2. The memory cells in the same layer may be connected to the same wordline among wordlines WL(1), WL(2), . . . , WL(n−1), WL(n). Each string select line and each ground select line may extend in the second direction D2, and the string select lines SSL11, . . . , SSLi2 and the ground select lines GSL11, . . . , GSLi2 may be formed in the third direction D3. Each wordline may extend in the second direction D2, and the wordlines WL(1), . . . , WL(n) may be formed in the first direction D1 and the third direction D3. Each bitline may extend in the third direction D3, and the bitlines BL(1), . . . , BL(m) may be formed in the second direction D2. The memory cells MC3 may be controlled by a voltage on the wordlines WL(1), . . . , WL(n).

Similarly to the NAND flash memory device, in the vertical flash memory device including the memory cell array 3110c, a read operation and a program operation may be performed per page, and an erase operation may be performed per block.

Although not illustrated in FIG. 10, two string select transistors included in a single string may be connected to a single string select line, and two ground select transistors included in the single string may be connected to a single ground select line. According to some embodiments, the single string may include one string select transistor and one ground select transistor.

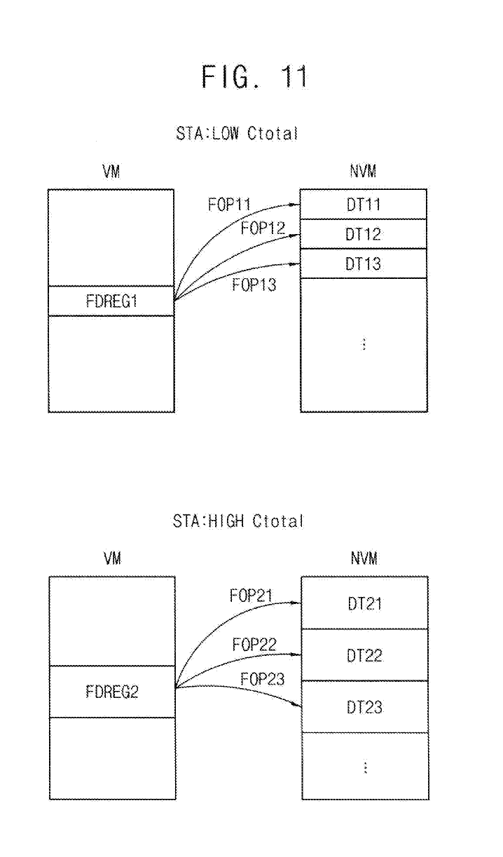

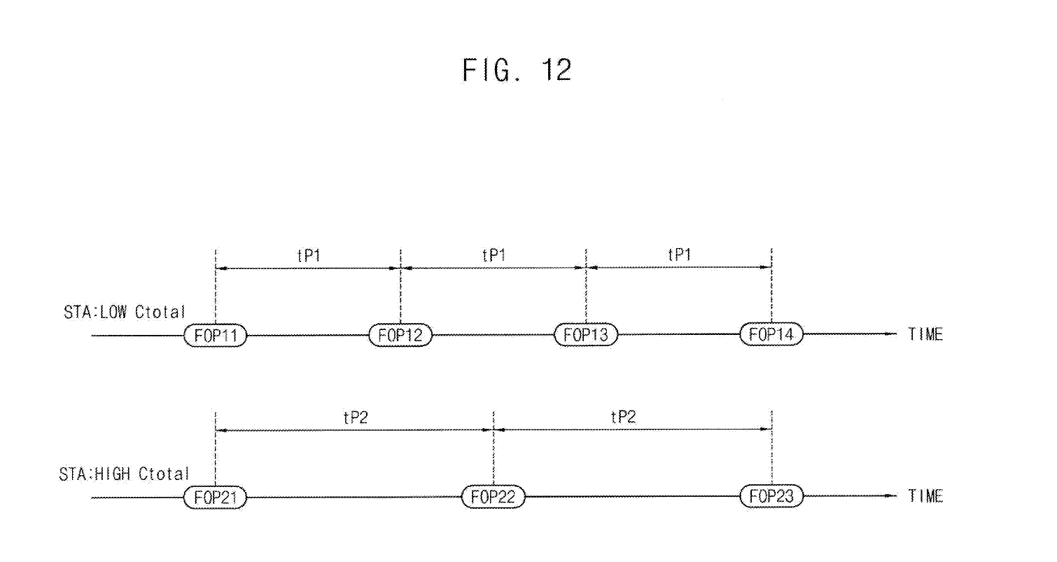

As described with reference to FIGS. 8 through 10C, the electronic device such as the storage device 3000 may include a volatile memory such as the buffer memory 3240 and the non-volatile memory 3100. The storage device 3000 may support a flushing operation to move flushing data stored temporarily in the volatile memory 3240 to the non-volatile memory 3100. For example, the flushing data may include meta data for control of the storage device 3000, write data transferred from the host device 2000, etc. To reduce performance gap with the host device 2000, the flushing data may be stored temporarily in the volatile memory 3240. The flushing operation may be performed periodically or non-periodically inside the host device 2000 so that the flushing data in the volatile memory 3240 may be moved and stored to the nonvolatile memory 3100. In this case, the flushing operation may be controlled based on the results of monitoring of the states of the capacitors included in the capacitor module as will be described below with reference to FIGS. 11 and 12.

FIG. 11 is a diagram illustrating an embodiment of controlling operations of an electronic device for the method of FIG. 1. The upper portion of FIG. 11 represents the flushing operation when the state signal STA indicates that the total capacitance Ctotal of the normal capacitors that are used for supplying the auxiliary power Pcap is relatively low, and the lower portion of FIG. 11 represents the flushing operation when the state signal STA indicates the total capacitance is relatively high.

As illustrated in FIG. 11, a maximum amount of the flushing data stored temporarily in the volatile memory VM may be controlled based on the total capacitance Ctotal of all of the capacitors that are connected electrically to the power rail for supplying the auxiliary power Pcap. When the total capacitance Ctotal is relatively low, the region FDREG1 for storing the flushing data in the volatile memory VM may be set with a smaller size. In this case, the size of the data DT11, DT12 and DT13 moved from the volatile memory VM to the nonvolatile memory NVM by the flushing operations FOP11, FOP12 and FOP13 may be reduced relatively. In contrast, when the total capacitance Ctotal is relatively high, the region FDREG2 for storing the flushing data in the volatile memory VM may be set with a larger size. In this case, the size of the data DT21, DT22 and DT23 moved by the flushing operations FOP21, FOP22 and FOP23 may be increased relatively.

As such, the maximum amount of the flushing data may be decreased as the total capacitance Ctotal is decreased. When the total capacitance Ctotal for supplying the auxiliary power Pcap is reduced, the maximum amount of the flushing data may be reduced so that the flushing operation may be performed more frequently. Even though the frequent flushing operation may degrade performance of the electronic device, the flushing operation may be completed with the small auxiliary power Pcap in case of unexpected interrupt in the input power Pin and thus the data loss may be prevented.

FIG. 12 is a diagram illustrating another embodiment of controlling operations of an electronic device for the method of FIG. 1. The upper portion of FIG. 12 represents the flushing operation when the state signal STA indicates that the total capacitance Ctotal of the normal capacitors that are used for supplying the auxiliary power Pcap is relatively low, and the lower portion of FIG. 12 represents the flushing operation when the state signal STA indicates the total capacitance is relatively high.

As illustrated in FIG. 12, a cyclic period of the flushing operation may be controlled based on the total capacitance Ctotal of all of the capacitors that are connected electrically to the power rail for supplying the auxiliary power Pcap. When the total capacitance Ctotal is relatively low, the cyclic period tP1 of the flushing operations FOP11˜FOP14 may be set to be shorter. In contrast, when the total capacitance Ctotal is relatively high, the cyclic period tP2 of the flushing operations FOP21˜F0P23 may be set to be longer.

As such, the cyclic period of the flushing operation may be decreased as the total capacitance Ctotal is decreased. When the total capacitance Ctotal for supplying the auxiliary power Pcap is reduced, the cyclic period of the flushing operation may be reduced so that the flushing operation may be performed more frequently. Even though the frequent flushing operation may degrade performance of the electronic device, the flushing operation may be completed with the small auxiliary power Pcap in case of unexpected interrupt in the input power Pin and thus the data loss may be prevented.

FIG. 13 is a diagram illustrating a task queue included in the storage device in FIG. 8. Referring to FIG. 13, a task queue or a request queue 3260 may include a task manager 3262, a task storage 3264 and a status storage 3266.

The task manager 3262 is configured to manage the task storage 3264 and the status storage 3266. For example, if the host device 2000 transfers particular requests or tasks, for example, a request for storing data in or reading data from the nonvolatile memory 3100, the task manager 3262 may store the request in the task storage 3264. The task manager 3262 may store status of each stored request in the status storage 3266. The task manager 3262 may efficiently manage the data transferred between the host device 2000 and the storage device 3000 based on the information stored in the task storage 3264 and the status storage 3266.

As illustrated in FIG. 13, the task storage 3264 may include multiple task registers CRG1˜CRGN, where N is a natural number indicating a size of a number of the task registers CRG1˜CRGN. N may be referred to as a multi-queue depth. The storage device 3000 may store requests up to N requests corresponding to the multi-queue depth N. Each of the task registers CRG1˜CRGN may store task information including a task ID, transfer direction information, data size information, and a start address, for example. The task information may also include priority information. The status storage 266 may include multiple status registers RRG1˜RRGN. Each of status registers RRG1˜RRGN stores the status information of the tasks stored in the task registers CRG1˜CRGN, respectively.

In some embodiments, a maximum number of the requests that are stored in the request queue 3260 is based on a total capacitance Ctotal of all of the capacitors that are connected electrically to the power rail for supplying the auxiliary power Pcap. When the total capacitance Ctotal is relatively low, the maximum number of the requests that may be stored in the request queue 3260 may be set to be smaller. In contrast, when the total capacitance Ctotal is relatively high, the maximum number of the requests that may be stored in the request queue 3260 may be set to be greater.

As such, the maximum number of the request that can be stored in the request queue 3260 may be decreased as the total capacitance Ctotal is decreased. Even though performance of the electronic device may be degraded by reducing the maximum number of the requests, the uncompleted requests may be completed with the small auxiliary power Pcap in case of unexpected interrupt in the input power Pin and thus the data loss may be prevented.

With reference to FIGS. 11 through 13, the embodiments are described such that the performance of the electronic device may be reduced as the total capacitance Ctotal is decreased, but other embodiments are not limited to the particular embodiments.

FIG. 14 is a block diagram illustrating a mobile device according to some embodiments. Referring to FIG. 14, a mobile device 4000 may include at least one application processor 4100, a communication module 4200, a display/touch module 4300, a storage device 4400, and a buffer RAM 4500.

The application processor 4100 controls operations of the mobile device 4000. The communication module 4200 is implemented to perform wireless or wire communications with an external device. The display/touch module 4300 is implemented to display data processed by the application processor 4100 and/or to receive data through a touch panel. The storage device 4400 is implemented to store user data. The storage device 4400 may be an embedded multimedia card (eMMC), a solid state drive (SSD, a universal flash storage (UFS) device, etc. The storage device 4400 may include the power loss protection circuit and the capacitor module as described above to perform efficient management of power and performance of the mobile device 4000.

The buffer RAM 4500 temporarily stores data used for processing operations of the mobile device 4000. For example, the buffer RAM 4500 may be DDR SDRAM, LPDDR SDRAM, GDDR SDRAM, RDRAM, etc.

As described above, the electronic device and the method of managing power and performance of the electronic device according to some embodiments may supply the auxiliary power using the normal capacitors even though some capacitors are defective by monitoring whether each capacitor is defective and thus life span and reliability of the electronic device may be enhanced. In addition, the electronic device and the method of managing power and performance of the electronic device according to some embodiments may control the operations of the electronic device depending on degree of degeneration of the capacitors for supplying the auxiliary power by monitoring the total capacitance of all of the normal capacitors that are used to supply the auxiliary power and thus life span and reliability of the electronic device may be enhanced.

The concepts described herein may be applied to any devices and systems including a storage device. For example, the teachings presented herein may be applied to systems such as be a mobile phone, a smart phone, a personal digital assistant (PDA), a portable multimedia player (PMP), a digital camera, a camcorder, personal computer (PC), a server computer, a workstation, a laptop computer, a digital TV, a set-top box, a portable game console, a navigation system, etc.

The foregoing is illustrative of particular embodiments and is not to be construed as limiting thereof. Although particular embodiments have been described, those skilled in the art will readily appreciate that many modifications are possible in the embodiments without materially departing from the concepts described herein.

What is claimed is:

1. A method of managing power and performance of an electronic device, the method comprising:
providing a plurality of capacitors configured to be electrically connected to a power rail of the electronic device to supply auxiliary power to the electronic device when interrupt occurs in input power supplied to the electronic device;
monitoring states of the capacitors; and
controlling operations of the electronic device based on the results of the monitoring.

2. The method of claim 1, further comprising controlling electrical connections between the power rail of the electronic device and the capacitors based on results of the monitoring.

3. The method of claim 1, wherein monitoring the states of the capacitors includes:
electrically connecting each of the capacitors as a test capacitor to a test node; and
measuring an individual capacitance of the test capacitor based on at least one of a voltage and a current at the test node.

4. The method of claim 3, further comprising controlling electrical connections between the power rail of the electronic device and the capacitors based on results of the monitoring, including:
when the individual capacitance of the test capacitor is greater than a reference value, determining the test capacitor to be normal and enabling the test capacitor; and
when the individual capacitance of the test capacitor is smaller than the reference value, determining the test capacitor to be defective and disabling the test capacitor.

5. The method of claim 1, wherein monitoring the states of the capacitors includes:
connecting all of the capacitors that are determined to be normal electrically to a test node; and
measuring a total capacitance of all of the capacitors that are connected electrically to the test node.

6. The method of claim 5, wherein controlling the operations of the electronic device includes decreasing operational performance of the electronic device as the total capacitance is decreased.

7. The method of claim 5, wherein monitoring the states of the capacitors includes:
generating a state signal indicating the total capacitance; and
providing the state signal to an internal circuit of the electronic device.

8. The method of claim 1, wherein:
the electronic device includes a volatile memory and a non-volatile memory, and
controlling the operations of the electronic device includes controlling a flushing operation to move data stored temporarily in the volatile memory to the non-volatile memory.

9. The method of claim 8, wherein controlling the flushing operation includes controlling a maximum amount of the data stored temporarily in the volatile memory based on a total capacitance of all of the capacitors that are connected electrically to the power rail for supplying the auxiliary power.

10. The method of claim 9, wherein the maximum amount of the data is decreased as the total capacitance is decreased.

11. The method of claim 8, wherein controlling the flushing operation includes controlling a cyclic period of the flushing operation based on the total capacitance of all of the capacitors that are connected electrically to the power rail for supplying the auxiliary power.

12. The method of claim 11, wherein the cyclic period of the flushing operation is decreased as the total capacitance is decreased.

13. The method of claim 1, wherein:
the electronic device includes a request queue configured to store requests from a host device, and
controlling the operations of the electronic device includes controlling a maximum number of the requests that are stored in the request queue, based on the results of the monitoring.

14. The method of claim 13, wherein the maximum number of the request that are stored in the request queue is decreased as a total capacitance of all of the capacitors that are connected electrically to the power rail for supplying the auxiliary power is decreased.

15. A method of managing power and performance of an electronic device, the method comprising:
providing a plurality of capacitors configured to supply auxiliary power to the electronic device when an interrupt occurs in input power supplied to the electronic device;
monitoring whether each of the capacitors is defective;
controlling electrical connections between a power rail of the electronic device and each of the capacitors based on results of the monitoring;
monitoring a total capacitance of all of the capacitors that are connected electrically to the power rail for supplying the auxiliary power; and
controlling operations of the electronic device based on the total capacitance.

16. The method of claim 15, wherein controlling the operations of the electronic device includes decreasing operational performance of the electronic device as the total capacitance is decreased.

17. A method comprising:
measuring capacitances of a plurality of capacitors of an electronic device; and
changing an operation of the electronic device based on the capacitances of the capacitors;
wherein the capacitors are configured to supply auxiliary power to the electronic device when an interrupt occurs in input power supplied to the electronic device.

18. The method of claim 17, wherein
measuring the capacitances of the capacitors comprises measuring a total capacitance of less than all of the capacitors; and
changing the operation of the electronic device comprises changing the operation of the electronic device based on the total capacitance.

19. The method of claim 17, further comprising disabling one or more of the capacitors from supplying the auxiliary power based on the capacitance of the one or more of the capacitors.

20. The method of claim 17, wherein:
measuring the capacitances of the capacitors comprises measuring a capacitance of each of the capacitors; and
changing the operation of the electronic device comprises changing the operation of the electronic device based on a set of the capacitors wherein each of the capacitors of the set have capacitances greater than a threshold.
